(19) United States
(12) Patent Application Publication
(10) Pub. No.: US 2023/0385693 A1
(43) Pub. Date: Nov. 30, 2023

(54) LEARNED DENSITY ESTIMATION WITH IMPLICIT MANIFOLDS

(71) Applicant: THE TORONTO-DOMINION BANK, TORONTO (CA)

(72) Inventors: Jesse Cole Cresswell, Toronto (CA); Brendan Leigh Ross, Toronto (CA); Anthony Lawrence Caterini, TORONTO (CA); Gabriel Loaiza Ganem, TORONTO (CA)

(73) Assignee: THE TORONTO-DOMINION BANK, TORONTO, ON (CA)

(21) Appl. No.: 18/202,450

(22) Filed: May 26, 2023

Related U.S. Application Data
(60) Provisional application No. 63/350,337, filed on Jun. 8, 2022.
(60) Provisional application No. 63/346,814, filed on May 27, 2022.

(51) Int. Cl. G06N 20/00; G06N 7/01

(52) U.S. Cl. CPC G06N 20/00; G06N 7/01

(57) ABSTRACT

Probability density modeling, such as for generative modeling, for data on a manifold of a high-dimensional space is performed with an implicitly-defined manifold such that points belonging to the manifold is the zero set of a manifold-defining function. An energy function is trained to learn an energy function that, evaluated on the manifold, describes a probability density for the manifold. As such, the relevant portions of the energy function are “filtered through” the defined manifold for training and in application. The combined energy function and manifold-defining function provide an “energy-based implicit manifold” that can more effectively model probability densities of a manifold in the high-dimensional space. As the manifold-defining function and the energy function are defined across the high-dimensional space, they may more effectively learn geometries and avoid distortions due to change in dimension that occur for models that model the manifold in a lower-dimensional space.

### CROSS-REFERENCE TO RELATED APPLICATIONS

This application claims the benefit of U.S. Provisional Application No. 63/346,814, filed May 27, 2022, and U.S. Provisional Application No. 63/350,337, filed Jun. 8, 2022, the contents of each of which are hereby incorporated by reference in the entirety.

### BACKGROUND

This disclosure relates generally to density modeling of data on a manifold of high-dimensional space, and particularly to density modeling with implicit manifold modeling and energy-based densities.

Natural data is often observed, captured, or otherwise represented in a “high-dimensional” space of n dimensions ( [symbol] ). While the data may be represented in this high-dimensional space, data of interest typically exists on a manifold [symbol] having lower dimensionality [symbol] than the high-dimensional space (n>m). For example, the manifold hypothesis states that real-world high-dimensional data tends to have low-dimensional submanifold structure. Elsewhere, data from engineering or the natural sciences can be manifold-supported due to smooth physical constraints. In addition, data samples in these contexts are often drawn from an unknown probability distribution, such that effective modeling of data must both account for the manifold structure of the data and estimate probability only on the manifold—a challenging task to directly perform because the manifold may be “infinitely thin” in the high-dimensional space.

Typical approaches struggle to effectively model both the density and the shape of the manifold in the high-dimensional space. In general, approaches do not attempt to model the manifold and the probability density with respect to the high-dimensional space directly. Instead, many approaches model a probability density in an m-dimensional latent space and map points in the latent space to the higher-dimensional output space with a learned mapping f_{θ}: [symbol] → [symbol] .

This approach is referred to herein as “pushforward” models because they “push” sampled points into the high-dimensional output space from the m-dimensional space. There are many challenges with these approaches. Manifolds cannot, in general, be represented with a single parameterization, meaning that attempts to do so will incur either computational instability or the inability to learn probability densities within the manifold. In further examples, the manifold itself is not effectively modeled with m-dimensions. As such, while using such pushforward modeling approaches has provided significant results, e.g., for use as generative models, there remain significant practical and theoretical challenges to further improvement with this paradigm.

### SUMMARY

To model a much broader class of topologies more effectively, a manifold-defining function is trained to learn the manifold as a zero set (points at which the output of the manifold-defining function are zero) and an energy function is trained for the training data with respect to the learned manifold. The energy function and the manifold-defining function may each comprise computer models, such as neural networks, with trainable parameters. Both the manifold-defining function and the energy function may be trained natively with inputs in the same dimensionality as the training data set. Because the manifold-defining function defines the manifold as the positions at which it outputs zero, the manifold-defining function may define various geometries of a manifold effectively in the high-dimensional space, while off-manifold points to have non-zero output values. Similarly, although the energy function may be defined for and can generate an energy across the high-dimensional space, the values of interest for probabilistic functions are constrained to the manifold (as defined by the zero set of the manifold-defining function). The combination of the energy function in conjunction with the manifold-defining function may thus be considered a probability model for the training data, such that the energy function evaluated on the manifold may serve as a probability density. Embodiments of the combined energy function and manifold-defining function are referred to as an energy-based implicit manifold (EBIM).

To train the models, initially the manifold-defining function is trained to learn the manifold, which is then used in training of the energy function. Training the manifold-defining function may include training with an energy-based training function based on the training data points. A loss function for the manifold-defining function may include terms for encouraging the function to evaluate zero for training data points, evaluate non-zero for points that are not a part of the training data, and smooth the output function around the training data points. Because the manifold of a manifold-defining function is defined as the zero set, in some embodiments the manifold for the data set as a whole is defined as a combination (e.g., union or intersection) of the zero sets for multiple manifold-defining functions.

Using the manifold-defining function, the energy function may be trained to learn an energy density that, on the manifold, may represent a probability density. The energy function may be trained with a contrastive divergence loss function. The contrastive divergence loss function may use data points sampled from the energy density on the manifold. To effectively sample these points, a constrained Hamiltonian Monte Carlo sampling algorithm may be applied that accounts for the energy density and constrains sampled points to the manifold.

This provides an energy-based model with an implicitly-defined manifold that may be suitable for effective density modeling and may also be used as a probabilistic generative model. As the manifold-defining function defines the manifold implicitly and energy function is allowed to create non-zero values off-manifold (that do not effect on-manifold evaluation), this approach is able to more effectively models densities on a manifold.

### BRIEF DESCRIPTION OF THE DRAWINGS

FIG. 1 illustrates a computer modeling system 110 including components for probabilistic modeling of a high-dimensional space, according to one embodiment.

FIG. 2 illustrates a high-dimensional space in which data points lie along a manifold.

FIG. 3 illustrates training and operation of an energy-based implicit model (EBIM) for probability density estimation of a manifold, according to one embodiment.

FIG. 4 shows examples of describing a relevant region of the high-dimensional space by combining manifolds, according to one embodiment.

FIGS. 5-9 illustrate example comparisons of EBIM models with pushforward models, according to various embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

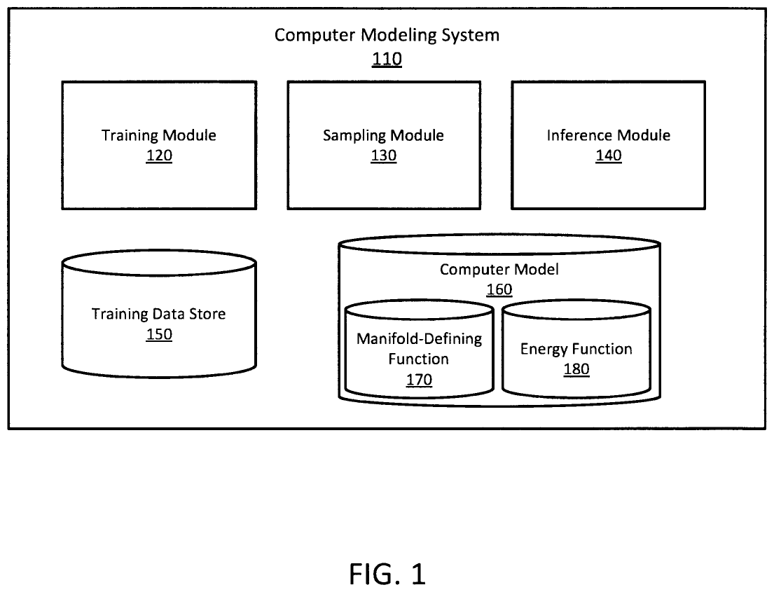

FIG. 1 illustrates a computer modeling system 110 including components for probabilistic modeling of a high-dimensional space, according to one embodiment. The computer modeling system 110 includes computing modules and data stores for generating and using a computer model 160. In particular, the computer model 160 is configured to model a probability density for data on a manifold [symbol] of an n-dimensional space. The n-dimensional space may also be referred to as a “high-dimensional” space to reflect that the manifold [symbol] may be representable in an m-dimensional space. Although some examples are provided below in simple examples of 2 or 3 dimensions, in practice, the high-dimensional space may represent images, chemical or biological modeling, or other data having thousands or millions of independent dimensions. As such, the manifold of the data in the high-dimensional space is typically “infinitely thin” with respect to the high-dimensional space. Formally, a training data store 150 contains a set of points xᵢ represented in n dimensions {xᵢ}⊂ [symbol] . The points xᵢ may also be referred to as training data samples and may be considered to be drawn from an unknown probability density p₍ₓ₎* to be modeled by the computer model 160. The model is trained to learn a probability density p₍ₓ₎ as represented by trained/learned parameters of the computer model based on the data points {xᵢ}. Formally, the data set may be considered drawn from a probability measure supported on the manifold [symbol] (e.g., having a “volume” with respect to the dimensionality of the manifold), but which, in the high-dimensional space, may lack a standard Lebesgue measure (i.e., there is no effective measure as a “volume” with respect to the n-dimensional space dimensionality of n).

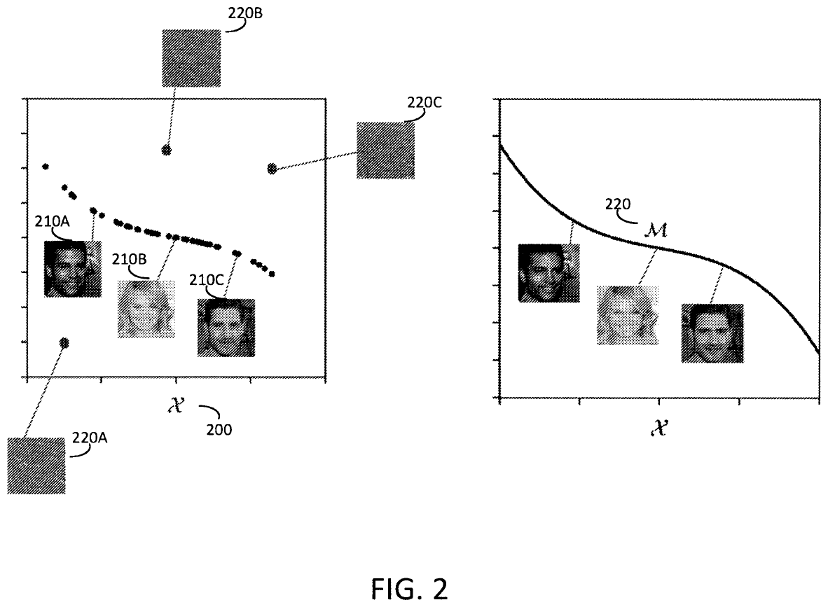

As such, the training data is modeled as existing on an m-dimensional manifold [symbol] of the high-dimensional space, in which the manifold is smooth and in which m is typically significantly smaller than n(m<<n). An example of such data is shown in FIG. 2. The computer model 160 includes a manifold-defining function 170 that is trained to learn the manifold and an energy function 180 that may be trained, such that evaluation of the energy function on the manifold may represent a probability density of the training data used to train the model. The computer model 160 is trained by a training module 120 according to the data samples in the training data store 150. Though referred to as “functions,” the manifold-defining function 170 and energy function 180 are typically implemented as computer models, such as neural networks, having trainable parameters for learning respective output values based on input points in the n-dimensional space. In general, embodiments include model architectures that are trainable based on respective loss functions and/or objectives as discussed below to yield “smooth” outputs in the respective output spaces. Such model architectures may include multi-layer perceptrons (MLPs), and neural networks with various types of layers that together implement the respective functions and may include various feedforward layers, activation layers, rectification layers, and so forth. As such, the particular structure of the models and/or algorithms implementing these functions vary in various embodiments.

After training, a sampling module 130 may sample outputs from the probability density represented by the combination of the manifold-defining function 170 and the energy function 180. The samples may represent probabilistic sampling on the learned manifold and thus represent “generative” modeling in the output space that differ from the individual data points in the training data store 150. This enables the model to generatively create outputs similar in structure and distribution to the data points of the training data in the training data store. Similarly, an inference module 140 may receive data points or a set of data points to perform probabilistic evaluations with respect to the learned probability density represented by the computer model 160. For example, data points off-manifold may be represented as having a probability measure of zero, and data points on-manifold may have a probability measure as described by the energy function at that point. Similarly, a group of data points may be evaluated with respect to whether it may be considered “in-distribution” or “out-of-distribution” with respect to the trained probability density. Further details of each of these aspects is discussed further below.

FIG. 2 illustrates a high-dimensional space in which data points lie along a manifold. In this example, the high-dimensional space 200 represents image data in two dimensions. Though shown in FIG. 2 as an example projection in two dimensions, each point of high-dimensional image data represents an image having dimensions that may have a value for each channel (e.g., 3 channels for RGB color) for each pixel across a length and width of the image. Hence, the total independent dimensional space for an image data point in the high-dimensional space 200, for this example, is the image length times the width times the number of channels times the bit length representing the color value: L×W×C×B. Stated another way, each color channel for each pixel across each pixel position of the image can have any value according to the bit length for that color channel. In practice, however, only some portions of the complete high-dimensional space may be of interest and are represented in the training set. While the range of the complete high-dimensional image data space can be used for any possible image, individual data sets typically describe a subset of the high-dimensional space 200. In this example, a data set of human faces includes data points 210A-C. However, many points in the image data space do not represent human faces and may have no visually meaningful information at all, such as data points 220A-C, depicting points in the high-dimensional space 200 that have no relation to the type of data of the human face data set. As such, while the high-dimensional space 200 may permit a large number of possible positions of data points, in practice, data sets (e.g., human faces) represent some portion of the high-dimensional space that may be characterized as a region often representable in fewer independent dimensions. The region of the high-dimensional space may be described as a manifold 230 of the high-dimensional space. As discussed below, the shape of the manifold 230 may be learned by the manifold-defining function to characterize the actual positions of data points in the high-dimensional space 200. The manifold 230 is thus learned to generally describe the “shape” of the data points within the high-dimensional space and may thus be considered to describe constraints on the areas in which data points exist and the interactions between them. For example, a data set of human faces may generally exist in a region of possible images in which there are identifiable facial features such as an identifiable nose, eyes, mouth, and depending on the pose of the face may include certain positional relationships among them or may generally be symmetrical, etc.

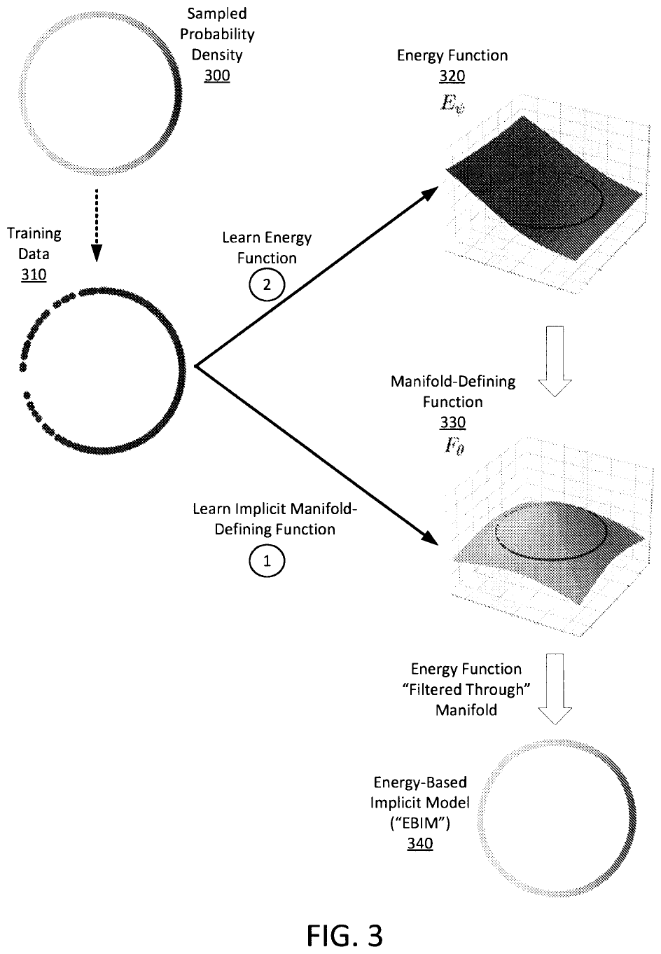

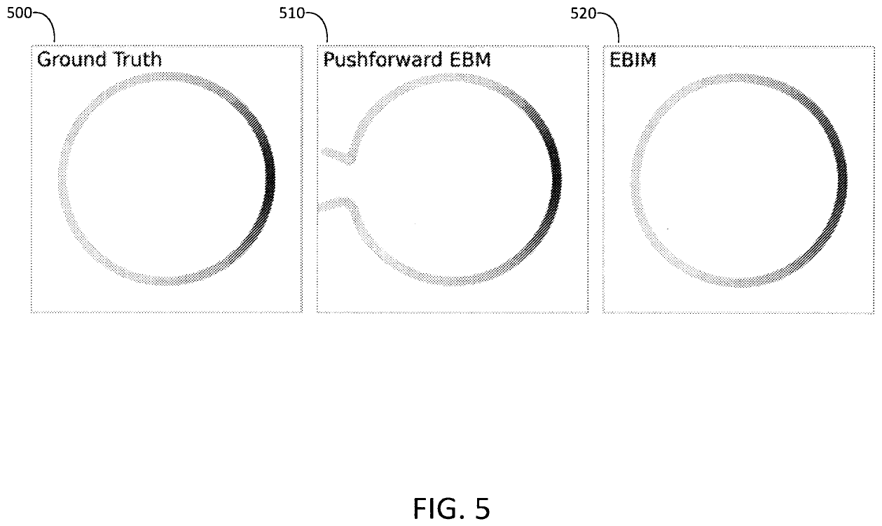

FIG. 3 illustrates training and operation of an energy-based implicit model (EBIM) for probability density estimation of a manifold, according to one embodiment. As discussed above, a set of training data 310 including several individual points is the data set that represents a sampled probability density 300. In some embodiments, such as the examples discussed below, the sampled probability density 300 is a known density, for example, to experimentally evaluate the effectiveness of a learned probability density in describing the “source” probability density. That is, to evaluate whether data points sampled from a known probability density can successfully be used to recreate that known probability density in the modeling. In the example of FIG. 3, the sampled probability density 300 is a Von Mises circle in two dimensions, having a relatively higher probability density on the right side of the x-axis and a relatively lower probability density on the left side of the y-axis. Accordingly, the training data 310 sampled for the example of FIG. 3 are relatively dense on the right side of the circle and relatively sparse on the left side. As shown by this example, although the training data is sampled in (and represented in) two-dimensions, it lies on a one-dimensional manifold defined by a line curved to form the circle. As shown in FIG. 5 and discussed below, even for this relatively simple toy example, pushforward models (e.g., that learn a one-dimensional manifold and pushforward a probability density in the one-dimensional space to the two-dimensional output space) often fail to correctly capture the density and the manifold.

To model the manifold, a manifold-defining function 330 is trained to learn the manifold as particular output values of the manifold-defining function. In various embodiments, the Manifold [symbol] is defined by the zero set of the manifold-defining function 330. The zero set are the set of points in the n-dimensional space that, when input to the manifold-defining function 330, yield an output of zero. Formally, the inverse of the zero set of the manifold-defining function F_{θ} with parameters θ defines a respective Manifold [symbol] _{θ}: [symbol] _{θ}:=F_{θ}⁻¹({0}). Although throughout this disclosure the zero set is used with the value of zero as the manifold-defining output value, other values may equivalently be used that permits the manifold-defining function 330 to learn parameters that define the manifold. The manifold may also be referred to as “implicitly-defined” because, rather than specifying the manifold itself, the manifold is defined with respect to the output of the manifold-defining function.

In one embodiment, the manifold-defining function 330 outputs values in multiple dimensions to account for the independent dimensions in which the n-dimensional space may vary that are not accounted for by the dimensionality of the manifold. In one embodiment, the manifold-defining function is thus defined as F_{θ}: [symbol] → [symbol] , such that the output of the manifold-defining function 330 has a dimensionality based on a difference of the high-dimensional space n and the dimensionality m of the manifold. Where the zero set defines the manifold, this allows the manifold-defining function to learn to distinguish non-manifold points from the zero set in the any of the different output dimensions, enabling the manifold-defining function 330 to learn more complex geometries. That is, because points on the manifold are evaluated as a zero value across the output dimensions n-m of the manifold-defining function, any nearby points that are not on the manifold may be evaluated as non-zero for any of the n-m output dimensions. In further embodiments, the manifold-defining function 330 may provide a different output dimensionality that provides for effective representation of the manifold [symbol] and sufficient dimensional freedom to represent the manifold shape. Because the manifold-defining function 330 can receive points in the native high-dimensional space to evaluate the zero set, native high-dimensional space is not distorted in defining or making use of the manifold, and the implicit definition allows for complex contours of the manifold to be learned with the flexibility of the different output dimensions allowed by the manifold-defining function 330.

The energy function 320 outputs an energy density for points in the n-dimensional space: E_{ψ}: [symbol] → [symbol] . As shown in FIG. 3, the energy function 320 may thus be evaluated for any point in the high-dimensional space. When evaluated with respect to the manifold defined by the manifold-defining function 330, the energy function 320 may estimate a probability density of the training data as an energy-based implicit model (“EBIM”) 340. That is, although the energy function 320 could be evaluated for off-manifold points, the relevant portion of the energy function 320 is “filtered” through the manifold of the manifold-defining function. As discussed below with respect to training, this allows the energy function 320 to be evaluated to any energy density for off-manifold points that are then discarded when “filtered through” the manifold.

Accordingly, the energy-based implicit model 340 is a function of both the energy function 320 and manifold-defining function 330 (and their parameters), and together the trained models (designated by *) may be represented as an energy-based implicit model as a pair of trained models (F_{θ*}, E_{ψ*}), that define a probability density P_{θ*, ψ*} of the trained density model E_{ψ*} with respect to the manifold θ* defined by the trained manifold-defining function F_{θ*}.

As shown below with respect to the examples in FIGS. 5-9, this approach may provide significant improvements for modeling manifold densities compared to “pushforward” models.

### Training an Implicit Manifold-Defining Function (MDF)

As shown by FIG. 3, the training module 120 may first train the manifold-defining function and then, based on the learned manifold, learn an energy density that, when evaluated on the learned manifold, is an estimate of the probability density.

To train the manifold-defining function 330 that effectively defines the manifold-defining function as a zero set, the manifold-defining function 330 such that its parameters evaluate to zero for the training data and are smoothly defined on the manifold. In one embodiment, training of the manifold-defining function 330 aims to satisfy three conditions:
1. F_{θ}(x)=0 for all x∈ [symbol]
2. F_{θ}(x)≠0 for all x [symbol] [symbol]
3. J_{f}_{_{θ}}(x) has full rank for all x∈

[symbol]

To satisfy condition 1, the loss function encourages the manifold-defining function to learn parameters that output a zero for each training data point xᵢ. Since [symbol] is the support of P*, condition 1 can be encouraged in one embodiment by the minimizing [symbol] _{x˜P*}∥F_{θ}(x)∥ with respect to the data points xᵢ. That is, P* represents the unknown probability distribution from which training data samples are drawn, such that ∥F_{θ}(x)∥ is evaluated with respect to the data points xᵢ.

Condition 2 represents ensuring that only on-manifold points belong to the zero set for the manifold-defining function. In one embodiment, this may be performed by identifying off-manifold points (i.e., not in the training data) having a low magnitude (e.g., points for which ∥F_{θ}(x)∥ is close to zero). Where the training data points xᵢ may represent “positive” points for which the manifold-defining function should output zero, these points may represent the most-relevant “negative” points for which the MDF should be encouraged to output non-zero values. To implement this, the model is encouraged to increase the output value of the manifold-defining function at these “negative” for these points, for example by maximizing the norm for these points. To identify these low-magnitude points, the manifold-defining function may be sampled as though the manifold-defining function described an energy density by applying Langevin dynamics sampling with respect to minimized values of ∥F_{θ}(x)∥ for points that are not in the training data. The application of this approach to obtain off-manifold points (i.e., not in the training data) based on the manifold-defining function F_{θ} may be considered a sampling distribution P_{θ}.

To satisfy condition 3 and provide that the manifold-defining function is smooth when evaluated on the manifold may be equivalent to ensuring the Jacobian of the MDF is non-zero for manifold points. In one embodiment, to do so, the Jacobian evaluated on the manifold is bounded away by encouraging non-zero magnitudes of the Jacobian as: ∥v^{t}J_{F}_{_{θ}}(x)∥ for the all unit-norm v∈ [symbol] .

Combining these terms yields a loss function [symbol] (θ) for the parameters θ manifold-defining function F_{θ} for minimizing the expectation:

[symbol]

(θ)= [symbol] _{(x, x′, v)˜(P*, P}_{_{θ}}_{, U(S))}[∥F_{θ}(x)∥−α[∥F_{θ}(x′)∥+β(η−∥v^{T}J_{F}_{_{θ}}(x)∥₊²] Equation 1

In which:
Points x are sampled from the training data;
Points x′ are sampled from the sampling distribution P_{θ} in which ∥F_{θ}(x)∥ is treated as an energy;
U(S) is the uniform distribution on the unit sphere S:={x∈ [symbol] :∥x∥=1},
the ReLU function is denoted (·)₊; and
α, β, and η are hyperparameters determining the negative sample weighting, the rank-regularization weighting, and the minimum singular value of J_{f}_{_{θ}}, respectively.

In one embodiment, the ReLU function is replaced with the Identity function, particularly for relatively high-dimensional applications. This loss function of Equation 1 is one example loss function that may be minimized in training the parameters of the manifold-defining function.

Including the additional two conditions as regularization terms may help avoid degeneracy in the manifold-defining function, losing smooth manifold definition or allowing off-manifold points to join the zero set.

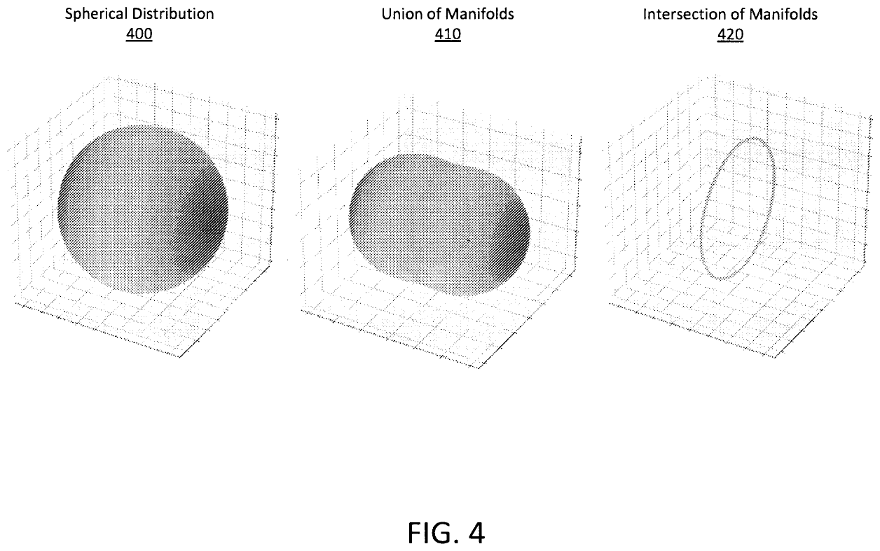

FIG. 4 shows examples of describing a relevant region of the high-dimensional space by combining manifolds, according to one embodiment. Some data sets might satisfy multiple constraints, which may be learned separately before combining into a mixture or product of models. Since implicit manifolds are defined by the zero set, which may be similarly defined by combinations of implicit manifolds, the energy function may operate effectively as a probability density on any defined “region” through which the energy function can be filtered. As such, the region in high-dimensional space for which the energy function is learned and for which the overall energy-based implicit model describes a probability density, which may be composed of a combination of manifolds described by individual manifold-defining functions. For example, each manifold-defining function may be learned based on data labeled with a particular characteristic or type. The zero set of these individual MDFs may be combined as a union or intersection to define a combined region of interest. For example, the union may represent a region describing either of two manifolds (e.g., learned for two different labels).

Examples of these combinations is shown in FIG. 4. First, a spherical distribution 400 is shown that may be learned by a manifold-defining function. In this example, the spherical distribution 400 is duplicated and translated in different directions for combination as a union of manifolds 410 or an intersection of manifolds 420. As such, combining individual manifolds may be used to model complex structures that cannot effectively be modeled as a single manifold.

### Constrained Energy-Based Modelling

Returning to FIG. 3, the energy function 320 is trained with respect to the defined region of interest in the high-dimensional space (e.g., the manifold of the manifold-defining function 330). When training the energy function, gradients for the energy function are determined for points in the region in the n-dimensional space defined by the manifold [symbol] _{θ}. Similarly, when using the energy function 320 for probability inference or sampling (e.g., to obtain new points in the high-dimensional space), the density of the energy function 320 is only considered for the region defined by the manifold [symbol] _{θ}. As the energy function can evaluate inputs across the high-dimensional space but is trained with points on the manifold, the energy function 320 may freely allow the energy density of off-manifold points to be affected by training gradients to optimize parameters for evaluation as a probability density when evaluated on the manifold. Considered another way, because the energy function is “filtered” through the manifold-defining function 330, the energy function is not constrained to minimizing or otherwise accounting for the energy density of off-manifold points because these “off-manifold” densities are discarded when “filtered” through the manifold-defining function 330.

As such, the energy function can be evaluated as a probability density only on the defined manifold, the energy function may be considered a constrained energy-based model, in which the energy is constrained to the region of the manifold. As a function of the manifold-defining function and the energy function, the density may be defined as:

$${p}_{{θ}^{*} , ψ} ( x ) = \frac{{e}^{- {E}_{ψ} ( x )}}{{\int }_{{{θ}^{*}}_{}} {e}^{- {E}_{ψ} ( y )} dy} , x ∈ {{θ}^{*}}_{}$$

where dy can be equivalently thought of as Riemannian volume form or Riemannian measure of [symbol] _{θ*}. Similarly, the resulting probability measure is represented as P_{θ*, ψ*}.

As the energy function is defined on the manifold of high-dimensional space, optimization of its gradients directly with respect to the data point distribution is typically intractable. Instead, the energy function may be trained in some embodiments with a contrastive divergence that learns gradients based on the training data points and points sampled from the current energy function. In one embodiment the contrastive divergence is defined as:

$${∇}_{ψ} log {p}_{{θ}^{*} , ψ} ( {x}_{i} ) = - {∇}_{ψ} {E}_{ψ} ( {x}_{i} ) + {𝔼}_{x \sim {P}_{{θ}^{*} , ψ}} [ {∇}_{ψ} {E}_{ψ} ( x ) ]$$

In which points are sampled from the probability distribution P_{θ*, ψ} for the expectation of the right-most term.

To sample points from the probability distribution P_{θ*, ψ}, an individual points may be sampled with a manifold-aware Markov Chain Monte Carlo (MCMC) methods such as a constrained Hamiltonian Monte Carlo (CHMC) sampling. These approaches permit sampling from a probability distribution by exploring the space point-to-point based on the local energy density. Although CHMC is typically applied to analytically known manifolds, it is adapted here to manifolds implicitly defined by neural networks.

Points are sampled by iteratively changing calculating a momentum and determining a subsequent step. The sampling process begins with an initial position x that is updated at each iteration that each apply a step to update the position of x for a number of k iterations.

First, a momentum r may be determined at the current point x by initializing the momentum with a Gaussian sample: r′˜N(0, Iₙ) and then projecting it to the null space of J_{F}(x^{(t)}) (written as J_{F} for clarity). The projection to the null space for the momentum r may be defined as:

r←r′−J_{F}_{_{θ*}}^{T}(J_{F}_{_{θ*}}J_{F}_{_{θ*}}^{T})⁻¹J_{F}_{_{θ*}}r′

Next, a new position may be determined by determining a constrained Lagrange multiplier λ*∈ [symbol] in that satisfies the requirement that the next step is on the manifold, such that the manifold-defining function evaluates the point to as the null set: F(x^{(t+1)})=0. In one embodiment, this may be determined by solving the following minimization, for example via stochastic gradient descent or L-BFGS:

$${λ}^{*} ← arg {min}_{λ} ‖ {F}_{{θ}^{*}} ( x + ε r - \frac{{ε}^{2}}{2} {∇}_{x} {E}_{ψ} - \frac{{ε}^{2}}{2} {J}_{{F}_{{θ}^{*}}}^{T} λ ) ‖$$

Finally, the next position for x can be determined with a Leapfrog step using the constrained Lagrange multiplier λ*:

$$x ← x + ε r - \frac{{ε}^{2}}{2} {∇}_{x} {E}_{ψ} ( x ) - \frac{{ε}^{2}}{2} {{J}_{{F}_{{θ}^{*}}}^{T} ( x )}^{T} {λ}^{*}$$

in which ε is a step size.

In some embodiments, as explicitly constructing the Jacobian J_{F}_{_{θ*}} can be unstable and memory-prohibitive, this is generated without directly constructing it. This permits more efficient determination of the steps above using the Jacobian of the manifold-defining function J_{F}_{_{θ*}}. Using efficient Jacobian-vector product and vector-Jacobian product routines, any expression in the form of J_{F}w for w∈ [symbol] or J_{F}^{T}v=(v^{t}J_{F})^{T} for v∈ [symbol] is tractable. Furthermore, the inverse term of J_{F}_{_{θ*}}^{T}(J_{F}_{_{θ*}}J_{F}_{_{θ*}}^{T})⁻¹J_{F}_{_{θ*}}r′ can be computed using a conjugate gradients (CG) routine and forward-backward auto-differentiation. CG allows computation of expressions of the form A⁻¹b, where A is an (n−m)×(n−m) matrix. In particular, CG requires access only to the operation v [symbol] Av, not the matrix A itself.

In this case, b=J_{F}r′ is a Jacobian-vector product and the operation is v [symbol] J_{f}J_{f}^{T}v, which is again computable as a vector-Jacobian product followed by a Jacobian-vector product. Since J_{F} is a wide matrix, this operation may be most efficiently performed using backward-mode followed by forward-mode auto-differentiation.

The two steps described above constitute a single iteration of constrained Langevin dynamics. In practice, many iterations are required to obtain a sample resembling the probability distribution P_{θ*, ψ*}. To obtain completely new samples (e.g., by the sampling module 130), a similar process may be followed by sampling random noise in ambient space and projecting it to the manifold by computing

$${{argmin}_{x}}_{λ} {‖ {F}_{{θ}^{*}} ( x ) ‖}^{2} .$$

### Example Experimental Results

FIGS. 5-9 illustrate example comparisons of EBIM models with pushforward models, according to various embodiments. These examples demonstrate the efficacy of EBIMs on a diverse range of topologically non-trivial data.

In each of these examples, all manifolds learned in these experiments were determined only based on samples, without additional knowledge. Quantitative comparisons of density estimates are challenging when manifolds are unknown: likelihood values are incomparable for different learned manifolds. Fortunately, these manifolds may be examined visually to illustrate the benefits of the EBIM approach.

The class of pushforward density estimation models is large; any can serve as a basis of comparison. In these experiments, a simple pushforward energy-based model was used consisting of an autoencoder with an energy-based model for the density in the latent space.

The first example, shown in FIG. 5, shows the relative success of an EBIM 520 in modeling a known ground truth 500 compared to a pushforward energy-based model 510. The ground truth shown here is the same as shown in FIG. 3 and illustrates the difficulty of the pushforward EBM 510 in correctly modeling the manifold itself, as the model does not effectively map the one-dimensional manifold to a complete circle. Meanwhile, the EBIM 520 correctly learned the manifold and its probability density.

### Von Mises Mixture

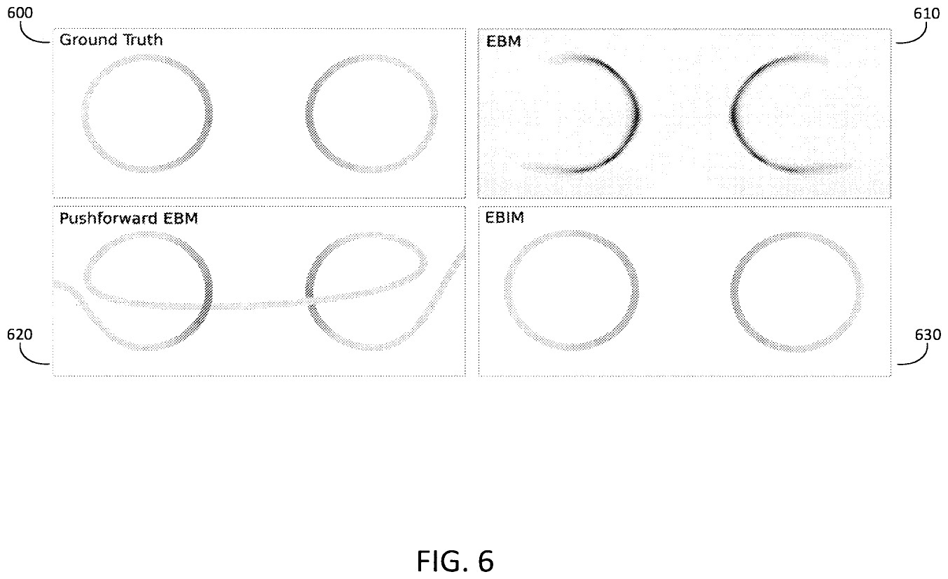

In FIG. 6, our first experiment, density estimation was performed on 1000 points sampled from a mixture of two von Mises distributions on circles embedded in 2D, shown as ground truth 600. Results for an ordinary EBM 610, a pushforward EBM 620, and an EBIM 630 are shown in FIG. 6. The topology of the density learned by the pushforward EBM 620 incorrectly connects and appears to be diffeomorphic except at two points of self-intersection. The EBIM 630, in contrast, captures the manifold, even in regions of sparsity. The ordinary EBM 610 is not subject to the topological limitations of the pushforward EBM 620, but still lacks the inductive bias to learn the low intrinsic dimension of the data.

Geospatial data

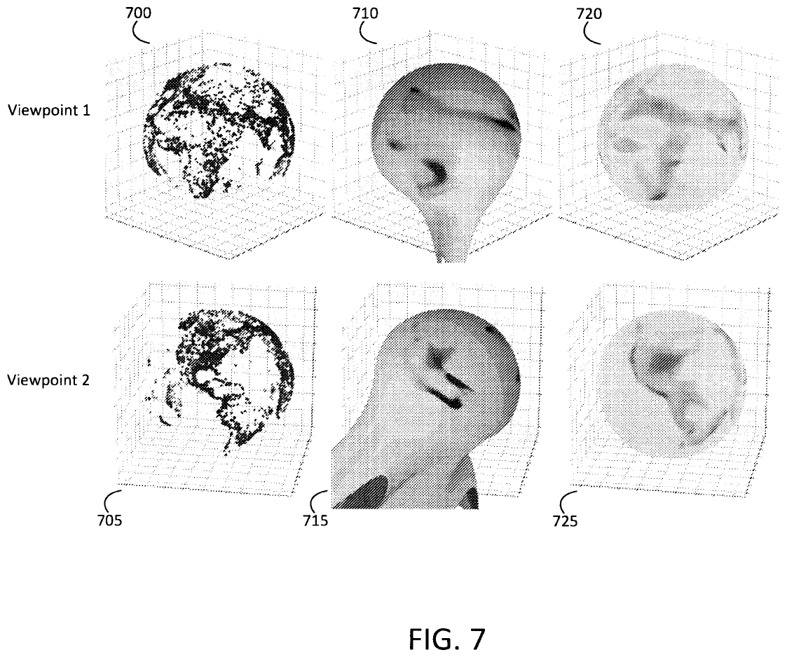

FIG. 7 models a data set of global flood events from the Dartmouth Flood Observatory that are embedded on a sphere representing the Earth. In FIG. 7, the top group of images represent a first viewpoint and the bottom group of images represent a second viewpoint for ground truth 700,705, pushforward EBM 710, 715, and EBIM 720, 725. Despite the relative sparsity of flood events compared to previous data sets (they only occur on land), the EBIM 720, 725 still perfectly learns the spherical shape of the Earth. The pushforward EBM 710, 715 represents the densities fairly well but struggles to learn the sphere and places some density off of the true manifold in the ground truth 700, 705. Note that the EBIMs 720, 725 and pushforward EBMs 710, 715 are plotted using a triangular mesh and mesh grid, respectively, due to the difference in how they are defined.

### Amino Acid Modelling

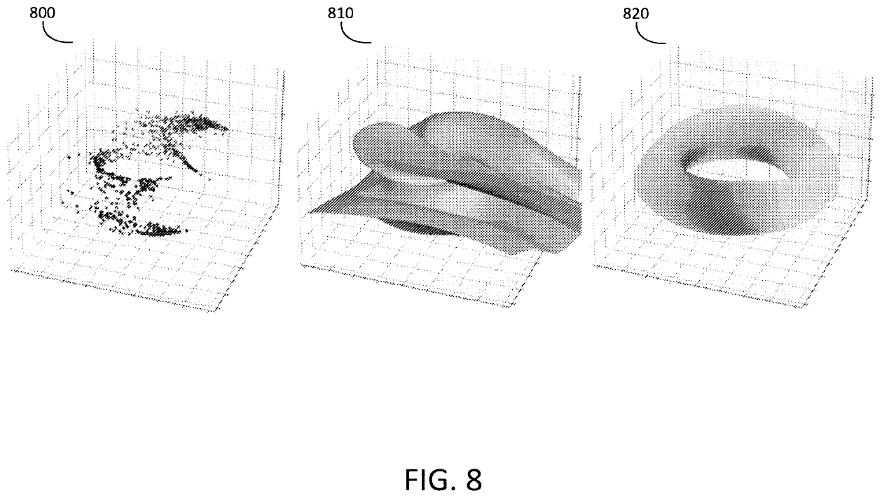

FIG. 8 relates to amino acid modeling that illustrates underlying toroidal geometries. The structure of amino acids can be characterized by a pair of dihedral angles and thus possesses toroidal geometry. Designing flexible probabilistic models for torus-supported data is consequently of interest in the bioinformatics literature on protein structure prediction; amino acid angle data is a practical candidate for evaluating the density estimation ability of EBIMs. In

FIG. 8, an EBIM 820 is compared with a pushforward EBM 810 using an open-source amino acid data set 800. The EBIM manifold-defining function learns the torus well in the presence of such sparse data. This may be because the torus is the simplest manifold matching the data's curvature. On the other hand, the pushforward EBM 810 was unable to reliably model the manifolds. This drop in performance is concerning because one might reasonably expect higher-dimensional data sets to have more complex topologies than a simple torus, but the corresponding misbehavior of the pushforward model is impossible to visualize and difficult to detect.

### Image Modelling

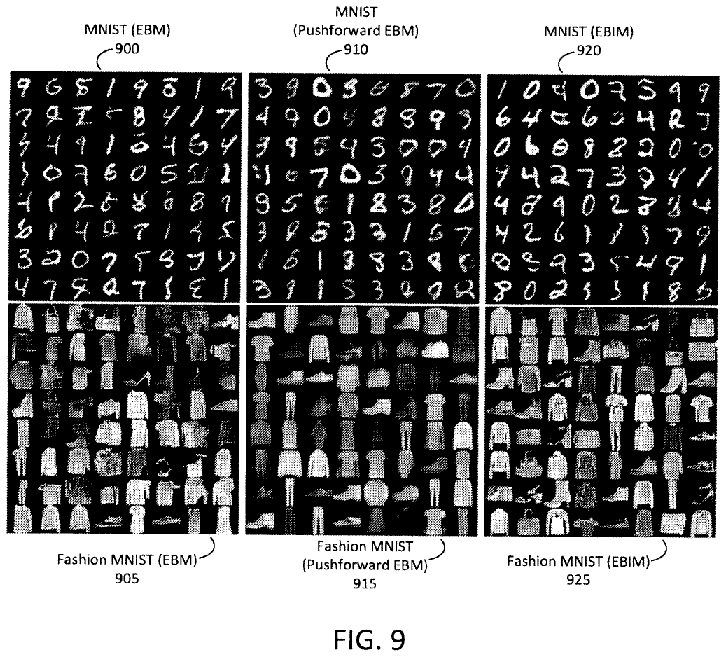

Finally, FIG. 9 shows that EBIMs can be scaled to higher-dimensional data manifolds the MNIST and Fashion MNIST image data sets.

The EBIM in this example uses a manifold dimension of 16, which is close to intrinsic dimension estimates of MNIST and Fashion MNIST. MDF has a model architecture parameterized with a small U-Net architecture modified from the implementation in the labml.ai Python package. The U-Net architecture includes skip connections give it full rank with a large output dimensionality (28×28−16=768). The constrained EBM has a simple convolutional architecture. Two baseline comparisons are provided: an ordinary EBM 900, 905 and a pushforward EBM 910, 915. Samples from all models are provided in FIG .9 with Fréchet Inception Distance (FID) scores (Heusel et al., 2017) in Table 1 for reference.

TABLE 1
FID Scores (lower is better)

| DATASET | EBM | PEBM | EBIM |
|---|---|---|---|
| MNIST | 16.34 | 28.27 | 20.72 |
| FMNIST | 52.18 | 74.37 | 42.27 |

The pushforward EBM 910, 915 consists of an autoencoder trained as a Gaussian VAE, and then an EBM 900, 905 on the latent space serving as a prior. Although its latent dimension should equal the manifold dimension to provide correct density estimates, reconstructions were poor with a dimension of 16 in the latent space. To improve performance of the pushforward EBM, the latent space instead used 30 latent dimensions to obtain reasonable samples. This mismatch points to an inability of pushforward models to accurately reflect the true geometric structure of complex data sets.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for probability density estimation on an implicitly-defined manifold, comprising:
one or more processors;
one or more non-transitory computer-readable media, containing instructions executable by the one or more processors for:
identifying a set of training data including a plurality of training data samples in a high-dimensional space;
training parameters of a manifold-defining function that learns a manifold of the set of training data in the high-dimensional space as a zero set output by the manifold-defining function, the manifold-defining function trained based on the plurality of training data samples; and
training parameters of an energy function based on the plurality of training data samples, the energy function outputting an energy density for points in the high-dimensional space, in which training of the energy function is constrained to the manifold.

2. The system of claim 1, wherein the energy function evaluated at a point of the manifold substantially describes a probability density of the point.

3. The system of claim 1, wherein the manifold-defining function and energy function are neural networks.

4. The system of claim 1, wherein the manifold-defining function is trained with a loss function including terms that encourage a) an output value of zero for the training data points, b) an output value of non-zero for positions in the high-dimensional space that are not training data points, and c) the manifold-defining function to be smooth at the training data points.

5. The system of claim 1, wherein the manifold for the energy function is the intersection or union of a first set of points associated with the zero set and a second set of points associated with another zero set of another manifold-defining function.

6. The system of claim 1, wherein training parameters of the energy function comprises training the energy function based on a contrastive divergence loss function.

7. The system of claim 6, wherein the contrastive divergence loss function includes points from the plurality of training data samples and a set of sampled points from the energy density on the manifold.

8. The system of claim 7, wherein training parameters of the energy function further comprises generating the set sampled points with a constrained Hamiltonian Monte Carlo sampling algorithm of the energy density on the manifold.

9. A method for probability density estimation on an implicitly-defined manifold, comprising:
identifying a set of training data including a plurality of training data samples in a high-dimensional space;
training parameters of a manifold-defining function that learns a manifold of the set of training data in the high-dimensional space as a zero set output by the manifold-defining function, the manifold-defining function trained based on the plurality of training data samples; and
training parameters of an energy function based on the plurality of training data samples, the energy function outputting an energy density for points in the high-dimensional space, in which training of the energy function is constrained to the manifold.

10. The method of claim 9, wherein the energy function evaluated at a point of the manifold substantially describes a probability density of the point.

11. The method of claim 9, wherein the manifold-defining function and energy density function are neural networks.

12. The method of claim 9, wherein the manifold-defining function is trained with a loss function including terms that encourage a) an output value of zero for the training data points, b) an output value of non-zero for positions in the high-dimensional space that are not training data points, and c) the manifold-defining function to be smooth at the training data points.

13. The method of claim 9, wherein the manifold for the energy function is the intersection or union of a first set of points associated with the zero set and a second set of points associated with another zero set of another manifold-defining function.

14. The method of claim 9, wherein training parameters of the energy function comprises training the energy function based on a contrastive divergence loss function.

15. The method of claim 14, wherein the contrastive divergence loss function includes points from the plurality of training data samples and a set of sampled points from the energy density on the manifold.

16. The method of claim 15, wherein training parameters of the energy function further comprises generating the set sampled points with a constrained Hamiltonian Monte Carlo sampling algorithm of the energy density on the manifold.

17. A non-transitory computer-readable medium for probability density estimation on an implicitly-defined manifold, the non-transitory computer-readable medium comprising instructions that, when executed by a processor, cause the processor to:
identify a set of training data including a plurality of training data samples in a high-dimensional space;
train parameters of a manifold-defining function that learns a manifold of the set of training data in the high-dimensional space as a zero set output by the manifold-defining function, the manifold-defining function trained based on the plurality of training data samples; and
train parameters of an energy function based on the plurality of training data samples, the energy function outputting an energy density for points in the high-dimensional space, in which training of the energy function is constrained to the manifold.

18. The non-transitory computer-readable medium of claim 17, wherein the energy function evaluated at a point of the manifold substantially describes a probability density of the point.

19. The non-transitory computer-readable medium of claim 17, wherein the manifold-defining function and energy function are neural networks.

20. The non-transitory computer-readable medium of claim 17, wherein the manifold-defining function is trained with a loss function including terms that encourage a) an output value of zero for the training data points, b) an output value of non-zero for positions in the high-dimensional space that are not training data points, and c) the manifold-defining function to be smooth at the training data points.
